(19) United States
(12) Patent Application Publication
(10) Pub. No.: US 2006/0105121 A1
(43) Pub. Date: May 18, 2006

(54) Pet as edge seal for multilaminated compositions

(76) Inventor: Andrea Cruz, Bogota (CO)

Correspondence Address: JACOBSON HOLMAN PLLC, 400 SEVENTH STREET N.W., SUITE 600, WASHINGTON, DC, 20004, US

(21) Appl. No.: 10/548,305

(22) PCT Filed: Mar. 4, 2004
(86) PCT No.: PCT/US04/06469

§ 371 Date: Dec. 5, 2005

(30) Foreign Application Priority Data
Mar. 4, 2003 (US) 60451263

(51) Int. Cl. E06B 3/00; B32B 17/10; E06B 5/00

(52) U.S. Cl. 428/34; 428/447; 428/480; 428/423.1

(57) ABSTRACT

This invention provides an edge seal that employs Polyethylene Terephthalate (PET) adhered to the edge of a laminated glass by a layer adhesive material in order to improve the protection against environmental conditions. The edge seal claimed by this invention also acts as a scratch resistant material, helping to prevent edge marring during handling, transport and installation of the laminated glass product. This edge can be applied to architectural or transportation laminated glass constructions, either flat or curved, including bullet resistance glass.

### FIELD OF THE INVENTION

This invention is related to automotive and architectural Laminated Glass (LG), which includes Bullet Resistant Glass (BRG). Specifically, it relates to edge seals for laminated glass.

A laminated glass construction is composed by several layers of glass joined with different polymers (e.g. polyvinyl butyral, polyurethane) and usually a layer of polycarbonate (in the case of BRG), with the purpose of absorbing energy to avoid penetration of foreign objects. FIG. 1 shows a scheme of a typical BRG laminated glass construction.

Making reference to FIG. 1, a typical illustrative BRG laminated glass construction can be formed by a plurality of laminated glass sheets (1) sandwiched between films of polyvinyl butyral (PVB) (2) (where polyurethane can also be used), and an inner layer of polycarbonate (3) joined to the glass sheets by a layer of polyurethane (5). There is also a final hard coat layer (4) used to prevent the splinter glass projection under ballistic attacks, which is joined to the polycarbonate with another layer of polyurethane. Other polymers can also be used in these layers, such as acrylic, EVA, polyester, polyethylene ionomer, Surlyn® (Sentry Glass Plus), acrylic resin and any ionomeric modification of these polymers. These layers can be of uniform thickness or may have different thickness according with the protection level of the laminated construction. In addition, the glass and polymer layers can be located in any order within the construction, without necessarily following the strict order illustrated in FIG. 1. A typical laminating process consist of introducing the plies comprising the laminated glass construction into an autoclave, where the construction is subjected to pressure and temperature conditions for a time required to laminate all the materials.

As used herein, the following terms are understood to mean:

Glass: Refers to any translucid, vitreous-ceramic or ceramic material (e.g. soda-lime, boro-silicate, alumino-silicate, silica); that may be used as layer in a laminated glass construction;

Laminated Glass: a construction composed by one or more glass layers bonded together with one or more films of polymeric material;

Bullet Resistant Glass (BRG): a laminated glass construction that affords a defined resistance against the firing of specified weapons and ammunitions, according to international standards such as European Committee for Standardization (CEN-EN1063), Underwriters Laboratory (UL-752), and National Institute of Justice (NIJ-0108.01);

TPU (PU-E): Polyurethane thermoelastomer Film.

PET: Polyethylene Terephthalate;

Edge: All planar, rounded or beveled surfaces that run along the perimeter of some or all the layers composing a Laminated Glass;

Edge Seal: Construction composed by one or more layers of materials that is used for covering the edge in a laminated Glass.

Laminated glass preferably requires boundary protection along its edge in order to prevent or at least prolong water vapor and solvent migration to the interfaces between the different layers making up the laminated glass. FIG. 2a illustrates an edge seal (5) along a laminated glass structure with an offset layer (20) that is nor covered by the edge seal. FIG. 2b illustrates another laminated glass structure (without an offset layer) with an edge seal (5) that covers all of the layers. Once water vapor penetrates the laminated glass structure it will eventually reach the interface with the polymer film, typically PVB. As shown in FIG. 4, since PVB has a hygroscopic molecular structure, the PVB film absorbs the molecules of S water into its polymeric matrix, which eventually migrate to the interface between the glass and PVB and create a breaking or repulsion effect between the adhesion bonds of the PVB and the glass. When the adhesion bonds break down the layers start to delaminate, creating an unsightly bubble within the laminated glass and eventually

compromising the integrity of the entire structure.

In order to try and solve the foregoing problem, commercially available laminated glass is typically protected along its edge with a film of polyurethane (TPU). This edge seal also provides shock-absorbing protection to prevent edge cracks in the laminated glass. However, TPU has important shortcomings that prevent it from providing an effective solution to the problems it pretends to solve. For one, TPU has water vapor permeability

of 25 g/cm2.day.bar, allowing water vapor migration to affect the integrity of the laminated glass in unacceptably short periods around (i.e. less than 24 months). Additionally, TPU has another important complication that arises from the application of primers and adhesives used to install the laminated glass. These adhesive compounds (e.g. aromatics such as methyl di-isocyanate (MDI), toluene di-isocyanate (TDI), aromatics di-isocyanates, etc.) chemically attack the structure of TPU, specifically breaking down the molecular structure and inducing increased permeability that permits the migration of the aromatic isocyanates to the interior of the laminated glass. Temperature fluctuations also make the TPU film expand and contract, which also favors the diffusion of aromatic isocyanates compounds into the laminated glass. The water vapor present in the laminated glass then catalyzes a cross-link reaction between the aromatic isocyanates and the TPU of the laminated glass (see FIG. 5), all of which results in the generation of a commercially unacceptable yellowish hue in the laminated glass and the loss of adherence between the TPU and the glass layers.

The prior art discloses attempts at solving the foregoing problems. EP 0391 165 A3 describes the sealing of the edge of an automotive glass laminate by means of a synthetic resin of the fluoropolymer, polybutene polymer or butylpolymer type applied to a planar or simple perimetral edge of the glass laminate. U.S. Pat. No. 5,908,675 teaches an edge seal comprised by a flowable ethylene-polymer-in-water emulsion to form a structure layer of the emulsion following a the macrogeometry of the edge specify the adhesive material. U.S. Pat. No. 6,649,695 teaches, at an edge sealed, the use of block copolymers that contain at least one polymer block which is composed of isobutene units and at least two further polymer blocks that are composed of units derived from vinylaromatic monomers. CN1344857 uses a neutral sealing silicone glue as an edge seal, which is compatible with PVB and waterproof. DE19824965 discloses a hot-melt adhesive as an edge seal that has been produced according to cast-resin technology. The inventive adhesive comprises acrylate or metacrylate homopolymers or copolymers or mixtures thereof. The invention also relates to a method for the production and to the uses of said hot-melt adhesive.

### SUMMARY OF THE INVENTION

In its preferred embodiment, this invention provides an edge seal that employs Polyethylene Terephthalate (PET) adhered to the edge of a laminated glass by a layer of TPU in order to improve the protection against the water vapor and solvent migration into the laminated glass construction. Moreover the PET in the edge imparts an attractive surface for the edge of the finished laminated glass product. This feature is highly appreciated by consumers in the laminated glass market. The edge seal claimed by this invention also acts as a scratch resistant material, helping to prevent edge marring during handling, transport and installation of the laminated glass product.

### BRIEF DESCRIPTION OF THE DRAWINGS

This invention will be further described with reference being made to the accompanying drawings, none of which are to scale and all of which are schematic in nature.

FIG. 1. Cross-sectional side view of an illustrative commercially available BRG laminated glass product with no edge seal.

FIG. 2a. Cross-sectional side view of a commercially available Edge Seal used in an offset laminated glass construction.

FIG. 2b. Cross-sectional side view of a commercially available Edge Seal used in a non-offset laminated glass construction.

FIG. 3. Schematic view of the bagging process required for this invention.

FIG. 4. Schematic view illustrating the detrimental effect of water molecules on the adhesion phenomena at the interface between the glass and PVB layers in laminated glass.

FIG. 5. Schematic view of the chemical reaction among TPU, water vapor and aromatic isocyanates.

FIG. 6. Schematic view preferred embodiment 1.

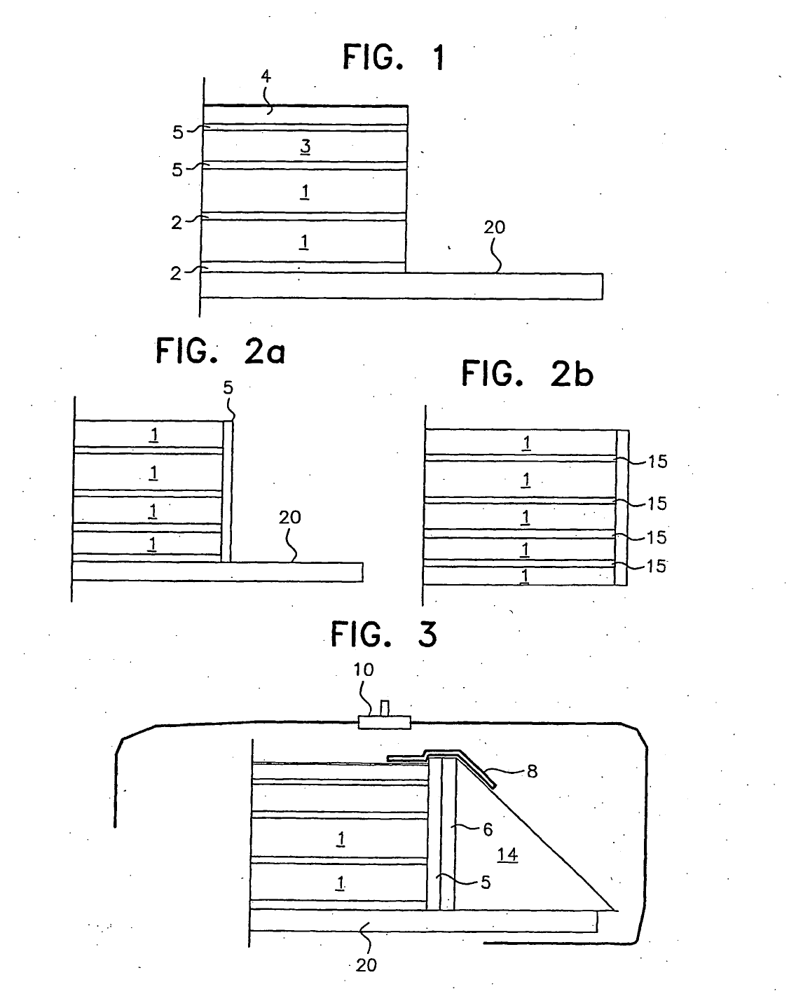

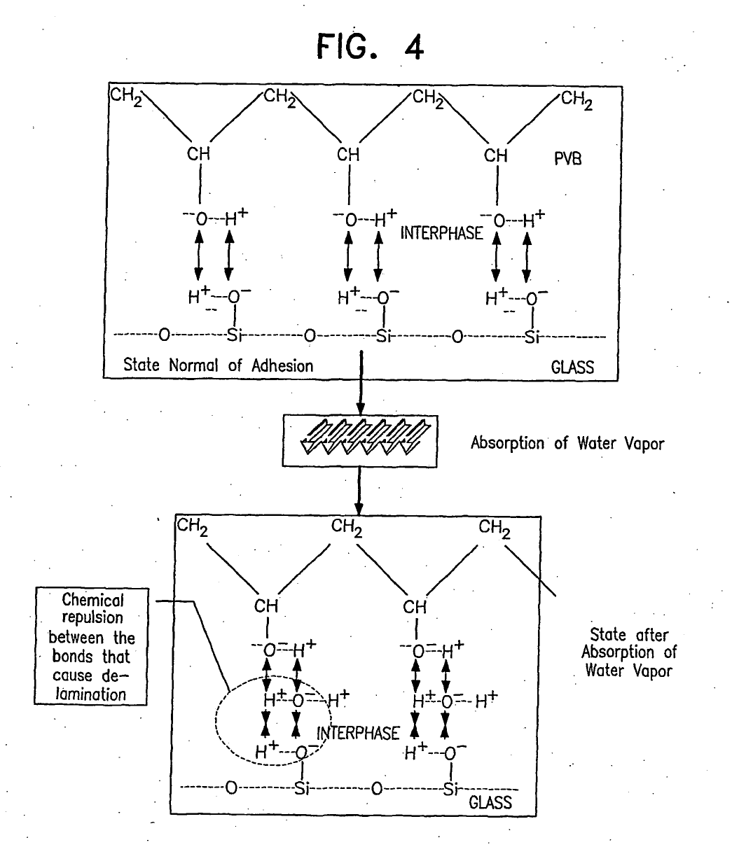

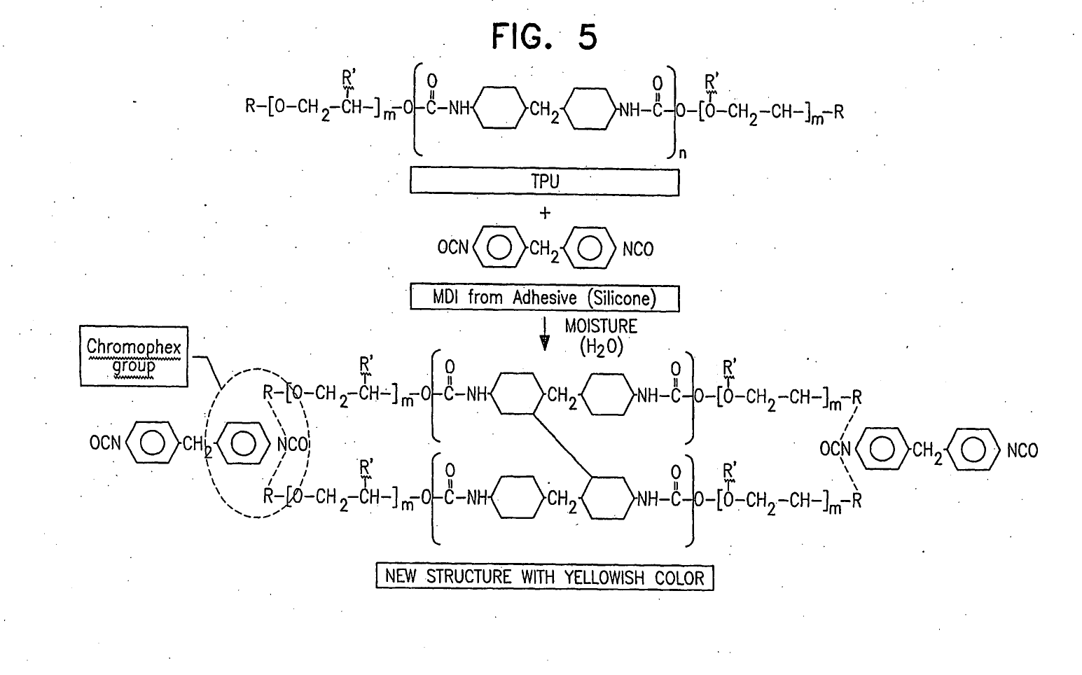

### DETAILED DESCRIPTION OF THE INVENTION

The literature shows there are different polymeric materials which have low permeability and high chemical resistance properties that could potentially present a solution to the problems exposed above, such as:

| | |
|---|---|
| Polyethylene High Density (PE-HD). | Polyacetal (POM). |
| Polyethylene Low Density (PE-LD). | Polyamide 12 (PA 12). |
| Polypropylene (PP). | Polyethyleneterepthalate (PET). |
| PolyVinylChloride Rigid (PVC-U). | |

In the Table 1 and 2 are shown the permeabilities and the chemical resistance of these materials. Polyurethane Elastomers (PU-E) is included for comparative purposes.

TABLE 1

| | | Film | | O₂ |
|---|---|---|---|---|
| | Temp. | Thickness | Water Vapor | (cm³/m² |
| Polymer | ° C. | (μm) | (g/cm² day) | day bar) |
| PE-LD | 23 | 100 | 1 | 2000 |
| PE-HD | 25 | 40 | 0.9 | 1890 |
| PP | 25 | 40 | 2.1 | 1900 |
| PVC-U | 20 | 40 | 7.6 | 87 |
| POM | 20 | 40 | 2.5 | 50 |
| PA 12 | 25 | 25 | 0.35 | 800 |
| PET | 23 | 25 | 8 | 110 |
| PU-E | 23 | 25 | 13 | 1000 |

TABLE 2

| | | | | Strong | Weak | | | | |
|---|---|---|---|---|---|---|---|---|---|
| | Hot | Weak | Strong | Alkali | Alkali | Aromatic | | Ketones | Organic |
| Polymer | Water | Acids | Acids | Sln | Sln | Hydrocarb. | Esters | Ethers | Acids |
| PE-LD | + | + | • | + | + | − | • | •/− | + |
| PE-HD | + | + | + | + | + | • | + | +/• | + |
| PP | + | + | • | + | + | • | • | •/− | • |
| PVC-R | + | + | + | + | + | − | − | − | − |
| POM | + | • | − | + | + | • | − | •/+ | + |
| PA 12 | + | − | − | + | • | + | + | +/+ | • |
| PET | + | + | • | • | − | + | + | +/+ | + |
| PU | + | • | − | • | • | − | + | −/− | − |
| Elastomers | | | | | | | | | |

+ Resistant
• Limited Resistance
− Not Resistant

In order to study adherence behavior with TPU and laminated glass, adherence tests using the polymers mentioned above were performed, obtaining the results found in Table 3. These materials were laminated in an autoclave process holding a 120-200 psi pressure at 95-140° C. temperature pursuant to ASTM D3167.

TABLE 3

| | | Adherence | Adherence | Adherence to |
|---|---|---|---|---|
| | | to TPU | to Glass | Polycabonate(PC) |
| | | ASTM 3167 | ASTM 3167 | ASTM 3167 |
| Polymer | Ciclo | (N/mm) | (N/mm) | (N/mm) |
| PE-LD | 1 | 0.5 | 0.5 | 0.1 |
| PE-HD | 1 | 0.0 | 0.0 | 0.0 |
| PP | 1 | 0.1 | 0.1 | 0.0 |
| PVC-U | 1 | 0.3 | 0.3 | 0.2 |
| POM | 1 | 0.0 | 0.0 | 0.2 |
| PA 12 | 1 | 1.0 | 0.1 | 0.5 |
| PET | 1 | 2.3 | 0.2 | 0.1 |
| PU-E | 1 | 25 | 0.0 | 23 |

From this table one can conclude that the first 5 polymers do not provide good adherence performance when laminated under the given laminating variables. In the same way, one can observe that the last three polymers offer an acceptable adhesion performance.

Chemical resistance test of the mentioned polymers were also perfomed using commercial adhesive compounds and other chemical substances found in primers, the results being tabulated in Table 4.

TABLE 4

| | | | | | | | | Methyl | |
|---|---|---|---|---|---|---|---|---|---|
| | PU | | Sulfuric | NaOH | NaOH | | | Ethyl | Acetic |
| | Sika | PU | Acids | 95% | 40% | Xilene/ | Ethyl | Ketone | Acid |
| Polymer | 256 | U-438 | (98%) | Sln | Sln | Toluene | Acetate | (95%) | (75%) |
| PE-LD | + | + | • | + | + | • | • | • | + |
| PE-HD | + | + | + | • | + | • | + | • | + |
| PP | + | + | • | + | + | • | • | • | • |
| PVC-R | + | + | • | + | + | − | − | − | − |
| POM | + | • | − | + | + | • | − | • | + |
| PA 12 | + | − | − | + | • | + | + | + | • |
| PET | + | + | + | • | • | + | + | + | + |
| PU | • | − | • | • | • | − | + | • | − |
| Elastomers | | | | | | | | | |

+ Resistant
• Limited Resistance
− Not Resistant

From this table one can observe that PET film has the highest chemical resistance as well. This test also confirms the limited resistance of the PU elastomer used in the prior art.

The crucial test, which clearly suggested that PET was the best option to be used as an edge seal, was the accelerated aging AGP-TLCC07 test (available from American Glass Products upon request, www.agpglass.com ). This type or test is widely used to simulate extreme environmental conditions on a laminated glass construction. The conditions of this test are: each cycle has a total duration of 240 hours; temperature ranging from −30 to +85° C.; relative humidity ranging from 0-50%; UV radiation intensity equal to 125 W/m² for the range of wave length between 220 to 630 nm, which generates 70.2 MJ/m² energy for the total cycle is duration. Two AGP-TLCC07 cycles are approximately equal to 1 year in-use period. At the end of each cycle, the laminated glass is searched for de-lamination defects, air bubbles, tears and fractures between any two bonded layers. The results are shown in Table 5, and demonstrate that PET as an edge seal was the one option that satisfied not only the processing requirements of laminated glass, but also the durability ones.

TABLE 5
Test Aging.

| POLYMER | CYCLE | CYCLE | CYCLE | CYCLE | CYCLE | CYCLE | CYCLE | CYCLE | CYCLE | CYCLE |
|---|---|---|---|---|---|---|---|---|---|---|
| FILM | 1 | 2 | 3 | 4 | 5 | 6 | 7 | 8 | 9 | 10 |
| PU-E | W | W | W | W | F | F | F | F | F | F |
| | W | W | W | W | W | W | F | F | F | F |
| | W | W | W | W | W | W | F | F | F | F |
| | W | W | W | W | W | W | W | W | F | F |
| | W | W | W | W | W | W | W | W | W | F |
| PET | W | W | W | W | W | W | W | W | F | F |
| | W | W | W | W | W | W | W | W | F | F |
| | W | W | W | W | W | W | W | W | W | F |
| | W | W | W | W | W | W | W | W | W | W |
| | W | W | W | W | W | W | W | W | W | W |
| PA 12 | W | W | W | F | F | F | F | F | F | F |
| | W | W | W | W | W | F | F | F | F | F |
| | W | W | W | W | W | W | W | F | F | F |
| | W | W | W | W | W | W | W | F | F | F |
| | W | W | W | W | W | W | W | W | F | F |
| Control | W | W | F | F | F | F | F | F | F | F |
| No edge | W | W | W | W | F | F | F | F | F | F |
| seal | W | W | W | W | F | F | F | F | F | F |
| | W | W | W | W | W | F | F | F | F | F |
| | W | W | W | W | W | W | F | F | F | F |

W = Perfect Conditions
F = Failure

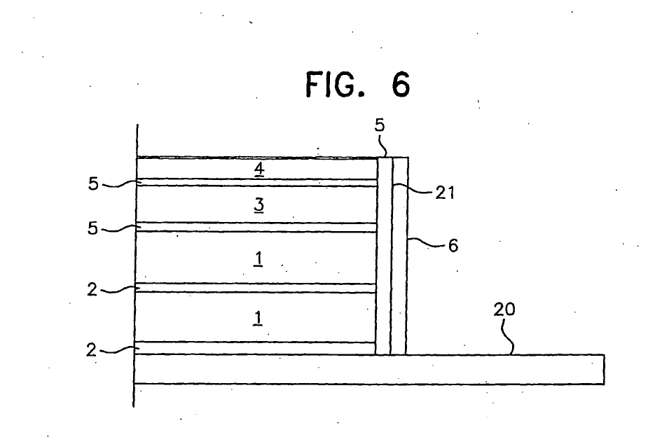

This invention relates to an edge seal made with a Polyethylene Terephthalate (PET) film, preferably treated with a hard coating of polysiloxane chemical family for improving the abrasion resistance. This PET film is adhered to the edge of the laminated glass by means of an adhesive sheet that may be made of a polyurethane thermo-elastomeric (TPU) material, butyral, acrylic or ethyl vinylic. In the most preferred embodiment illustrated in FIG. 6, an edge seal (21) is manufactured by combining a 0.18 mm thick PET layer (6) with a 0.62 mm Polyurethane adhesive sheet (PE399 Huntsman) (5). The PET layer is produced by stripping the PVB layer from the Spallshield® product sold by E.I. DuPont de Nemours (Wilmington, Del.), which is a combination PET/PVB film. This PET film also has a hard coating along its external surface (the one opposite the polyurethane sheet) provided by a polisiloxane treatment. Alternatively the PET film may be left untreated in order to optionally allow one or more additional layers of other materials to be added, for example black urethane.

The method for making this invention may be summarized as follows. The typical assembly process of laminated glass is well known amongst those versed in the art. In essence, it involves arranging (sandwiching) the glass (curve or flat shapes) and polymeric plies in an appropriate fashion in order to produce the finished laminated glass product. Once the plies are arranged, a polyurethane film is placed around the edge of the laminated assembly. Next, the PET film is applied over the polyurethane film. Once this assembly is fixed, the traditional pressure and temperature treatment can be applied in order to laminate the entire assembly and obtain the finished product. In order to guarantee the outlet of air from the laminated assembly (de-aeration is necessary in order to avoid leaving entrapped vapors or solvents), and since the presence of the PET film prevents these trapped substances from later being expelled (it was found that PET's lack of permeability is a hindrance in this regard), it was necessary to use a breathing film (8) along the exposed Polyurethane/PET interphase, preferably made from nylon (Bleeder Lease® B Airtech Co.). Additionally, to achieve good dimensional stability of the edge seal, a mold (14) with a triangular cross section made from silicone rubber with a hardness of 60-80 Shore A was applied along the edge seal. FIG. 3 illustrates this assembly. This assembly is provisionally fixed with tape, placed in a bag (9) connected to a vacuum system (10), vacuum is applied to a level of 20-21.5 in Hg. This vacuum level is held during all the laminating process, which is performed in an autoclave, maintaining 100-200 psi pressure and 95-140° C. temperature during approximately 6-12 hours. The exact value of these variables depends on the laminated glass product.

The use of PET as an edge protection for curve and flat Bullet Resistant Glass presented certain problems that had to be overcome. The main problems were the presence of air bubbles, wrinkles and partial loss of adhesion. Solutions to these problems obligated the inclusion of some modifications to the conventional manufacturing process of laminated glass products.

Air Bubbles: The formation of bubbles on any interface of the laminated glass indicates a direct loss of adhesion and the consequent decrease of ballistic properties and reduced life of the laminated glass product. The solution to this problem involves the use of the breathing film mentioned above and increasing the laminating pressure.

Wrinkles: PET is a material much more rigid than Polyurethane. Thus, it has been found that for curved laminated glass pieces, PET presents some difficulties to adapt to the composite curve (curve in 3-directions) on corners of automotive laminated glass pieces. It is widely known that laminated glass constructions require during the autoclave process a cover plate to laminate the upper polymeric ply (hard coated layer). The cover plate, which most of cases is a glass ply, is discarded after the autoclave process. To control the presence of these wrinkles, we have found an effective solution by cutting the cover plate 1.5 mm larger than the size of the laminated glass piece, just on the corners. The 1.5 mm space is then filled naturally by the melted Polyurethane used for bonding the upper polymeric ply to the laminated glass construction which is also cut 1.5 mm larger.

Partial Loss of Adhesion: It was found in some cases that the PET used as edge protection on curved and flat laminated glass constructions presented partial loss of adhesion manifested in point specific delaminations (5×5 mm sections). It was generally found that by increasing the holding laminating temperature by 4° C. was enough to overcome the problem.

What is claimed is:

1. An edge seal for laminated glass that includes a PET layer adhered to the edge of said laminated glass by means of one or more adhesive materials, wherein the PET layer is at least partially covered with a scratch resistant coating along its external surface.

2. The edge seal of claim 1, wherein the adhesive material is polyurethane.

3. The edge seal of claim 1, wherein the scratch resistant coating is comprised of polisiloxane material.

4. The edge seal of claim 1, wherein the laminated glass is bullet resistant glass.

5. The edge seal of claim 1, wherein the laminated glass is to be used in transportation applications.

6. The edge seal of claim 1, wherein the laminated glass is curved.

7. The edge seal of claim 1, wherein the scratch resistant coating is covered by one or more layers of additional material.

8. An edge seal for a laminated glass that includes a polymer layer to the edge of said laminated glass by means of one or more adhesive materials, wherein said polymer layer:
i) shares similar water vapor permeability, adherence and hardness characteristics as PET and;
ii) is at least partially covered with a scratch resistant coating along its external surface.
